(19) United States
(12) Patent Application Publication
(10) Pub. No.: US 2022/0000128 A1
(43) Pub. Date: Jan. 6, 2022

(54) METHOD AND SYSTEM FOR CREATING FRUIT WITH COLD RESISTANCE TO ENABLE COLD QUARANTINE

(71) Applicant: The State of Israel, Ministry of Agriculture & Rural Development, Agricultural Research Organization, Rishon Lezion (IL)

(72) Inventors: Noam ALKAN, Kidron (IL); Oleg FEYGENBERG, Holon (IL); Dalia MAURER, Holon (IL)

(21) Appl. No.: 17/291,287

(22) PCT Filed: Nov. 6, 2019
(86) PCT No.: PCT/IB2019/059538

§ 371 Date: May 5, 2021

Related U.S. Application Data
(60) Provisional application No. 62/756,084, filed on Nov. 6, 2018.

(51) Int. Cl. A23B 7/04; A23B 7/152

(52) U.S. Cl. CPC A23B 7/04; A23B 7/152

(57) ABSTRACT

The present invention provides systems and methods, which integrate artificial ripening, low temperature conditioning or acclimation, and modified atmosphere, to increase cold resistance in fruit. These processes prepare the fruit for additional processes, such as cold quarantining.

### CROSS-REFERENCES TO RELATED APPLICATIONS

This application is related to and claims priority from commonly owned U.S. Provisional Patent Application Ser. No. 62/756,084, entitled: System and Method for Fruits Quarantin, filed on Nov. 6, 2018, the disclosure of which is incorporated by reference in its entirety herein.

### TECHNICAL FIELD

The present invention is directed to preparing fruit for resistance to cold and in particular, resistance to processes such as cold quarantining.

### BACKGROUND OF THE INVENTION

Fruits and vegetables, collectively known as “produce” are typically grown in one country or region and consumed in another country or region. When such produce enters into a different country or region, it is normally subjected to quarantine treatments, to ensure that specific pests, which do not exist in the importing country or region, will not enter the local environment and invade the produce in the importing nation or region. To enable the export of fresh produce, quarantine treatments must eradicate all pests without compromising produce quality. Since methyl bromide use has been banned in most countries, several post-harvest methods for quarantine treatment have been developed, such as radiation, heat and cold treatments. However, these treatments have limitations: heat treatments can impair fruit sensory quality, radiation is relatively expensive and its application is complicated, and cold treatment may cause chilling injuries.

For example, mango is grown in areas with numerous pests, and consumed worldwide. Should these mango associated pests enter the importing nation or region, the potential for crop devastation is enormous. Pests from mango growing areas include fruit flies, such as the Mediterranean fruit fly (Ceratitis capitata), a pest which can devastate entire crops of produce. Accordingly, mangos are routinely quarantined upon entry into a nation or region, and heavily inspected for fruit flies.

Mango, by its very nature, is a tropical fruit, and very susceptible to damage and spoilage from cold storage (CS). Accordingly, cold quarantining has never been considered as a quarantining method. Thus, mango quarantining is based mainly on heat treatments, which can impair fruit sensory quality, as mentioned above.

While cold management of 18 days at 2.2° C. has been accepted by the United States Department of Agriculture (USDA) as a quarantine treatment against fruit flies for many fruit types, including mango, optimum cold-storage temperature for mangos is 12° C. Storage below this temperature can lead to the development of chilling injuries. These chilling injuries in mango are, for example, brown spots on the fruit, graying of the inner flesh of the fruit, softening and soft spots and irregular ripening in various parts of the fruit.

Many studies have focused on increasing fruit resistance to sub-optimal temperatures in order to extend fresh produce storage. Modified atmosphere (MA) reduces water loss and significantly reduces chilling in several fruits, including mango. Waxing of pomegranate and grapefruit also reduces chilling injury symptoms, and when used on mangos, storage periods are increased.

### SUMMARY

The present invention provides systems and methods for preparing fruit to be cold resistant, in order to sustain minimal, if any damage from cold treatments, such as those associated with cold quarantining. The present invention provides systems and methods, which integrate artificial ripening, low temperature conditioning or acclimation, and modified atmosphere, to increase cold resistance in fruit. As a result of the invention, the storage paradigm is reversed, as the fruit is first ripened and then stored, in comparison to storing the fruit as unripe and ripening the fruit only before the marketing. Therefore, tropical fruit, which is typically cold sensitive, can undergo cold quarantine.

Embodiments of the invention are directed to a method for treating fruit, for example, to prepare it for cooling processes such as cold quarantining. The method comprises: ripening the fruit; subjecting the fruit to a modified atmosphere to slow the metabolism of the fruit; and, conditioning the fruit for treatment by cooling processes, by gradually lowering the core temperature of the fruit by predetermined temperature amounts for predetermined time periods for a predetermined amount of time, to avoid cold shock in the fruit.

Optionally, the method is such that the ripening includes artificial ripening.

Optionally, the method is such that the artificial ripening includes subjecting the fruit to approximately 150 ppm ethylene in a ripening chamber.

Optionally, the method is such that the modified atmosphere includes a CO₂ at a concentration of approximately 4-7 percent, and to O₂ at a concentration of approximately 8-16%.

Optionally, the method is such that the conditioning includes cooling the fruit from core temperatures of approximately 12° C. to approximately 2° C., over a time period of at least three days, with each time interval being a day and the temperature difference between the time intervals no more than 7° C.

Optionally, the method is such that the subjecting the fruit to the modified atmosphere includes covering the fruit within a porous polymeric bag.

Optionally, the method is such that the porous polymeric bag includes a porous polyethylene bag.

Optionally, the method is such that the polyethylene is low density polyethylene (LDPE).

Optionally, the method is such that the porous polyethylene bag includes pores of approximately 0.5 mm diameter.

Optionally, the method is such that the covering the fruit within the porous polymeric bag includes the bag being closed.

Optionally, the method is such that the covering the fruit within the porous polymeric bag includes the bag being open.

Optionally, the method is such that the subjecting the fruit to a modified atmosphere and conditioning the fruit are performed simultaneously.

Optionally, the method is such that the fruit includes mango.

Embodiments of the invention are directed to a method for treating fruit, for example, to prepare it for cooling processes such as cold quarantining. The method comprises: artificially ripening the fruit; and, conditioning the fruit for treatment by cooling processes, by gradually lowering the core temperature of the fruit by predetermined temperature amounts for predetermined time periods for a predetermined amount of time, to avoid cold shock in the fruit.

Optionally, the method is such that it additionally comprises: subjecting the fruit to a modified atmosphere to slow the metabolism of the fruit.

Optionally, the method is such that the artificial ripening includes subjecting the fruit to approximately 150 ppm ethylene in a ripening chamber.

Optionally, the method is such that the modified atmosphere includes a CO₂ at a concentration of approximately 4-7 percent, and to O₂ at a concentration of approximately 8-16%.

Optionally, the method is such that the conditioning includes cooling the fruit from core temperatures of approximately 12° C. to approximately 2° C., over a time period of at least three days, with each time interval being a day and the temperature difference between the time intervals no more than 7° C.

Optionally, the method is such that the subjecting the fruit to the modified atmosphere includes covering the fruit within a porous polymeric bag.

Optionally, the method is such that the porous polymeric bag includes a porous polyethylene bag.

Optionally, the method is such that the polyethylene is low density polyethylene (LDPE).

Optionally, the method is such that the porous polyethylene bag includes pores of approximately 0.5 mm diameter.

Optionally, the method is such that the covering the fruit within the porous polymeric bag includes the bag being closed.

Optionally, the method is such that the covering the fruit within the porous polymeric bag includes the bag being open.

Optionally, the method is such that the subjecting the fruit to a modified atmosphere and conditioning the fruit are performed simultaneously.

Optionally, the method is such that the fruit includes mango.

Embodiments of the invention are directed to a method for treating fruit, for example, to prepare it for cooling processes such as cold quarantining. The method comprises: subjecting the fruit to a modified atmosphere to slow the metabolism of the fruit; and, conditioning the fruit for treatment by cooling processes, by gradually lowering the core temperature of the fruit by predetermined temperature amounts for predetermined time periods for a predetermined amount of time, to avoid cold shock in the fruit.

Optionally, the method is such that it additionally comprises: artificially ripening the fruit.

Optionally, the method is such that the artificially ripening the fruit includes subjecting the fruit to approximately 150 ppm ethylene in the ripening chamber.

Optionally, the method is such that the modified atmosphere includes a CO₂ at a concentration of approximately 4-7 percent, and to O₂ at a concentration of approximately 8-16%.

Optionally, the method is such that the conditioning includes cooling the fruit from core temperatures of approximately 12° C. to approximately 2° C., over a time period of at least three days, with each time interval being a day and the temperature difference between the time intervals no more than 7° C.

Optionally, the method is such that the subjecting the fruit to the modified atmosphere includes covering the fruit within a porous polymeric bag.

Optionally, the method is such that the porous polymeric bag includes a porous polyethylene bag.

Optionally, the method is such that the polyethylene is low density polyethylene (LDPE).

Optionally, the method is such that the porous polyethylene bag includes pores of approximately 0.5 mm diameter.

Optionally, the method is such that the covering the fruit within the porous polymeric bag includes the bag being closed.

Optionally, the method is such that the covering the fruit within the porous polymeric bag includes the bag being open.

Optionally, the method is such that the subjecting the fruit to a modified atmosphere and conditioning the fruit are performed simultaneously.

Optionally, the method is such that the fruit includes mango.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram in four parts, A, B C and D, of ripening parameters;

FIG. 2 is a diagram in two parts, A and B, of lipid peroxidation;

FIG. 3 is a diagram in six parts, A, B C, D, E and F, of releases aroma volatile compounds;

FIG. 4 is a diagram of a result of a cold quarantine of mango in accordance with the present invention; and,

FIG. 5 is a diagram in two parts, A and B, of cooling injury (CI) parameters.

Table 1 and Table 2 form part of this document.

### DETAILED DESCRIPTION OF THE INVENTION

The present invention provides systems and methods for preparing fruit to be cold resistant, in order to sustain minimal, if any, damage from cold treatments, such as those associated with cold quarantining. The present invention provides systems and methods for creating fruit with cold resistance to enable cold quarantining. The present invention provides systems and methods which integrate artificial ripening (AR), low temperature conditioning (LTC) or acclamation, and modified atmosphere (MA), to increase cold resistance in fruit. Artificial ripening (AR) occurs by multiple techniques, including, for example, allowing the fruit to ripen, such that the fruit begins to soften and starts to change color from green to yellow-orange, in an ethylene filled ripening chamber, ripening room, ripening vessel, or the like, as is standard in the produce industry. For example, harvested fruit is artificially ripened in a ripening chamber with an environment of 150 ppm (parts per million) ethylene, for a predetermined time period, such as approximately 24 hours. This artificial ripening may include additional storage in a temperature-controlled environment.

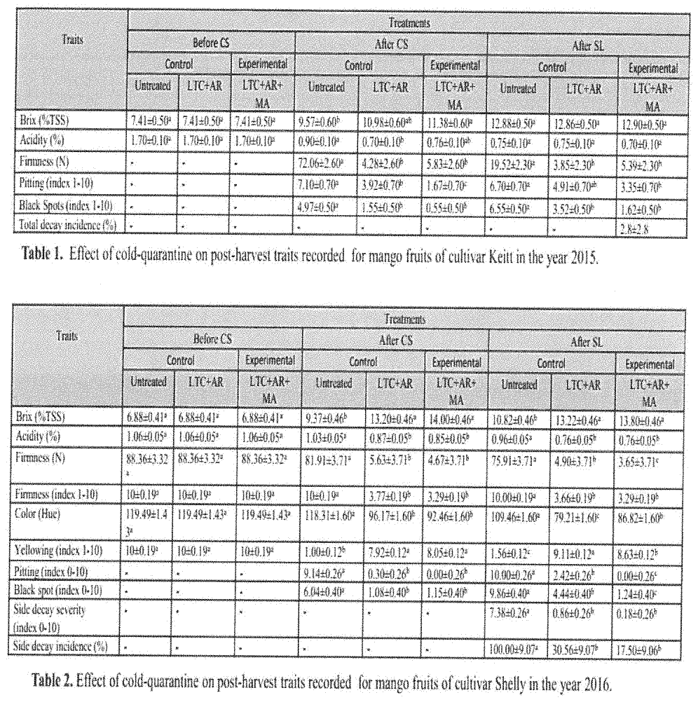

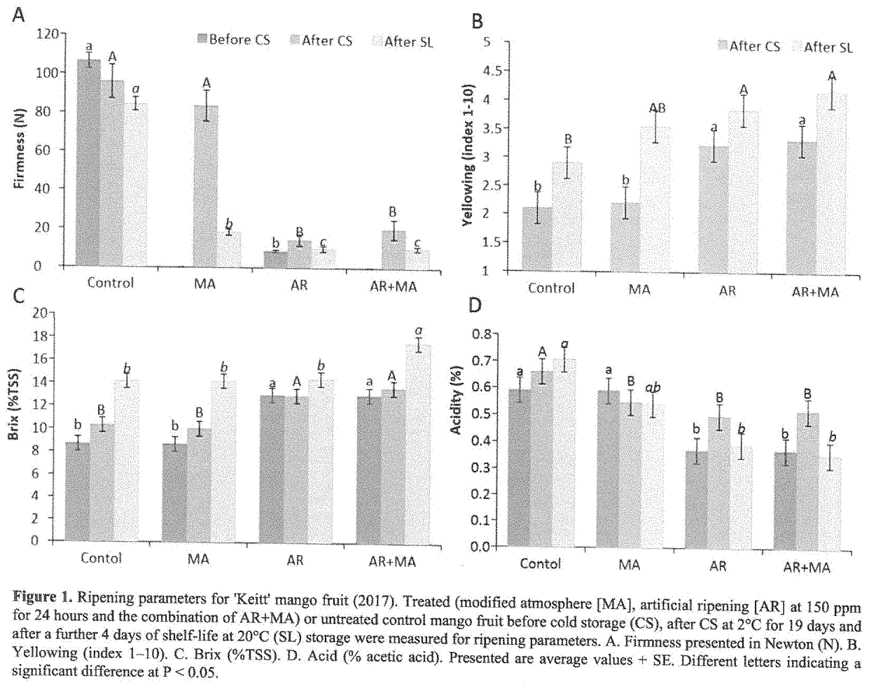

For example, a fruit, such as a mango, may be considered to be ripe when it begins to soften (lower than 20 newton in mango) and begins to change color (from green to yellow) (hue of yellow is lower than 95, in mango), and/or the soluble solids increase by more than 1.5% (in mango) and the acidity is reduced from that of the unripe fruit prior to AR (Table 1, Table 2, FIG. 1). Additionally, the USDA defines mangos as ripe when the fruit yields readily to slight pressure, and are ready for immediate consumption, as stated in, Mangos—Shipping Point and Market Inspection Instructions, USDA 2006, at page 9 of 21 pages.

The artificial ripening may be a first process performed before any other processes of the present invention, e.g., the subjecting the fruit to a modified atmosphere, and the conditioning process, detailed below. Alternately, the fruit can be ripened naturally or a combination of artificially ripened and naturally ripened.

For example, mango was artificially ripened in an environment (ripening chamber) of 150 ppm ethylene for 24 hours, followed by two days of storage (in a storage room) at 18° C.

The fruit is then subjected to a modified atmosphere, where the gas content in the atmosphere is controlled. The modified atmosphere exists for predetermined times, during the cold storage result in the reduction of chilling injuries. Additionally, the modified atmosphere serves to decrease oxygen (O₂) concentration in the fruit while increasing carbon dioxide (CO₂) in the fruit, to slow the metabolism in the fruit. This reduction of metabolism leads to reduced red and black spots, skin discoloration, pitting and the like, which leads to decay and off-taste in the fruit.

Modified atmosphere (MA) treatment includes, for example, covering fruits with perforated (porous) bags (e.g., such that the fruit is inside (within) the bags), such as polymeric bags, for example, polyethylene bags, including perforations (pores) such as 30 pores of approximately 0.5 mm diameter, and, for example, available from StePac of Israel. The Polyethylene bag is, for example, low density polyethylene (LDPE) (40 μm). Prior to covering the fruit with the polyethylene bag, the bags may be left open on the first day of covering for reducing humidity. In some cases the relative humidity inside the bag is about 97-100% without condensation. The Carbon Dioxide (CO₂) concentration inside the bag is, for example, approximately 4-7% (of the total gases in the modified atmosphere), while the oxygen (O₂) concentration is, for example, approximately 8-16% (of the total gases in the modified atmosphere). For example, the bags may also be closed (e.g., sealed), or a combination of time periods when the bags are open and closed.

The fruit is also subject to conditioning, also known as a conditioning process or acclamation (acclamation process), for low temperatures (e.g., approximately 2 degrees Celsius). The conditioning processes allows for gradual cooling to the predetermined temperatures over a predetermined time period (e.g., gradual cooling before reaching 2.2 degrees Celsius for 18 days, the standard for cold quarantining for the Mediterranean Fruit Fly), to avoid shocking (cold shock) to the fruit. The conditioning may be performed with one or both of the artificial ripening process and/or the modified atmosphere process, detailed above. The conditioning process involves a gradual lowering of the core temperature of the fruit, so that the fruit is not shocked by the suboptimal cold. The conditioning process involves lowering the temperature of the fruit by lowering the ambient environment temperature gradually, by temperature amounts, such as approximately 1-8 degrees Celsius, for a predetermined time interval, e.g., a day (24 hours), for a predetermined time period, e.g., three to five days. This time period or time span allows to begin at a starting temperature, e.g., 12 degrees Celsius, and finish at an end temperature, e.g., 2.2 degrees Celsius, which is the temperature for the cold quarantining process. The temperature amounts may be different between time intervals, and the time intervals may be of different time lengths.

The conditioning process, for example, a low temperature conditioning process, includes, a three day time period, where cooling on a first day (approximately 24 hours) includes reducing the temperature to approximately 12° C. at a relative humidity of approximately 80%, a second day (approximately 24 hours) to approximately at 5° C. at a relative humidity of approximately 82%, and a third day (approximately 24 hours) at approximately 2° C. at a relative humidity of approximately 75%.

The conditioning process may, for example, be followed by a storage period in a temperature controlled or ambient temperature (20° C.) environment.

Once the processes of artificial ripening, modified atmosphere and conditioning are complete, the fruit may be subjected to additional processing. This additional processing may include cold quarantining, for example, storage at approximately 2±0.25 degrees Celsius for 18 days.

The processes of artificial ripening, modified atmosphere and conditioning, are performed contemporaneous in time, and may be performed in any desired order. Additionally, the conditioning process may be performed simultaneously with the artificial ripening or modified atmosphere.

### EXAMPLES

### Example 1—Instrumentation

Firmness of fruit can be measured using an electronic penetrometer (such as LT-Lutron FG-20 kg, Indonesia) with an 11-mm probe at two points of the equatorial line of each fruit (20 measurement/treatment) via peel. Fruit color (hue) may be measured using a chromometer (such as Minolta, LR-400/410) at two points on the equatorial line of each fruit (20 measurement/treatment). Fruit total soluble solids (TSS) can be measured by a digital refractometer (such as ATAGO PR-1, Japan). Acid concentration can be measured by automatic titrator (such as Metrohm, 719S Titrino, Switzerland) and may be calculated for percent citric acid. The temperature in the cold-storage room can be monitored by a Data Acquisition (DAQ) tool—Double Strand wire Jogger/Data Acquisition control system (such as of that from T.M.I. Barak Ltd., Israel). Fruit core temperature can be monitored as well using a MicroLite Data Logger such as LITE5032P-EXT-A (Fourier Technologies, Israel). This can be done by inserting the probe on or near calyx part of the fruit, approximately 3 cm deep.

### Example 2—Artificial Ripening (AR) of Keitt and Shelly Cultivars of Mango Combined with Modified Atmosphere (MA) and Low Temperature Conditioning (LTC)

In this example, experimental results are presented for a combination of post-harvest treatments including AR, MA and LTC. The experiments were conducted on mango cultivars “Keitt” and “Shelly”. Experiments took place during the years 2015-2017. In these experiments, the experimental groups were compared with control groups which were either untreated before cold quarantining (CQ) or groups that underwent postharvest treatments before cold quarantine without artificial ripening.

Progression in Ripening Parameters during Cold Quarantine

Results of the experiments comparing parameters of ripening comparing between the experimental groups and the control groups of experiments took place during the years 2015 and 2016 are summarized in Tables 1 and 2 below. FIG. 1, at parts A through D, are graphs referring to the similar results from an experiment that took place at 2017.

It can be seen that firmness after cold storage is significantly lower in experimental groups; yellowing is higher in experimental groups; Fruit total soluble solids is higher in experimental groups especially before shelf life (SL), and acidity in experimental groups is lower, particularly before cold storage and after shelf life.

Lipid Peroxidation during Cold Quarantine

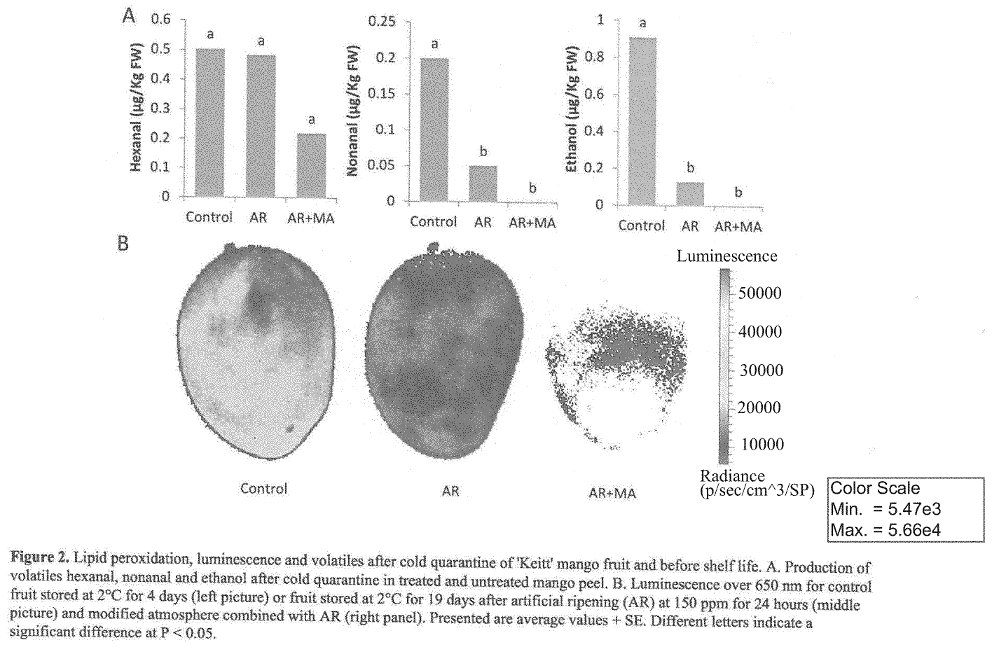

Lipid peroxidation associated with chilling injury could generate secondary compounds, including the volatile compounds, which could cause off-flavors in fruits. In FIG. 2 at Part A, there is shown gas chromatography-mass spectrometry (GC-MS) analysis results of peroxidation volatile products: hexanal, nonanal and ethanol, after cold quarantining in mango peel from the control groups and from the experimental groups. It is evident from Part A, that the production of volatiles in the experimental groups was significantly lower, i.e., concentrations of hexanal, nonanal and ethanol are significantly lower in the experimental groups.

Luminescence indicated that peroxidation was high in the untreated control group 7-10 days after cold quarantining at 2° C. In the experimental group that underwent low temperature conditioning plus artificial ripening (LTC+AR), luminance appeared after 19 days of cold quarantining, whereas in the experimental group that underwent LTC+AR (150 ppm ethylene for 24 hours) and modified atmosphere (MA), the indication of lipid peroxidation was very low throughout the experiment. The low luminance, which was appearing in the experimental group that underwent LTC+AR and MA, found to be as a prediction parameter of lower chilling injury. This is illustrated in FIG. 2, Part B, showing luminance measured for fruits in cold quarantine: (1) control group of untreated fruit (left); (2) experimental group of fruit that underwent LTC and AR (150 ppm of ethylene for 24 hours)(center); and, (3) experimental group that underwent LTC+AR and MA (right). Presented are average values plus standard error (SE). Different letters indicate a significant difference at P<0.05.

Effects of Cold Quarantine on Aroma Volatiles

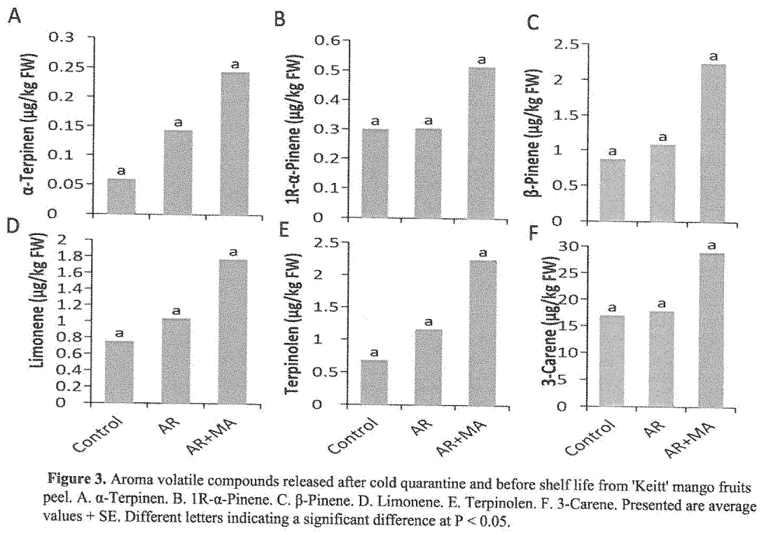

Several volatiles are known to contribute to the aroma of mango fruit. FIG. 3, at Parts A through F, includes graphs of concentration of desired aromatic volatile compounds released after CQ (before shelf life) from “Keitt” mango fruit peels. In FIG. 3, presented are: Part A α-Terpinen, Part B, 1R-α-Pinene, Part C β-Pinene, Part D Limonene, Part E Terpinolen, and Part F 3-Carene. Presented are average values plus standard error. Different letters indicate a significant difference at P<0.05. It is evident from the graphs that the concentrations of the desired aromatic volatile compounds are significantly higher in the experimental groups compared with the control groups.

Effects of Cold Quarantine on Acceptance

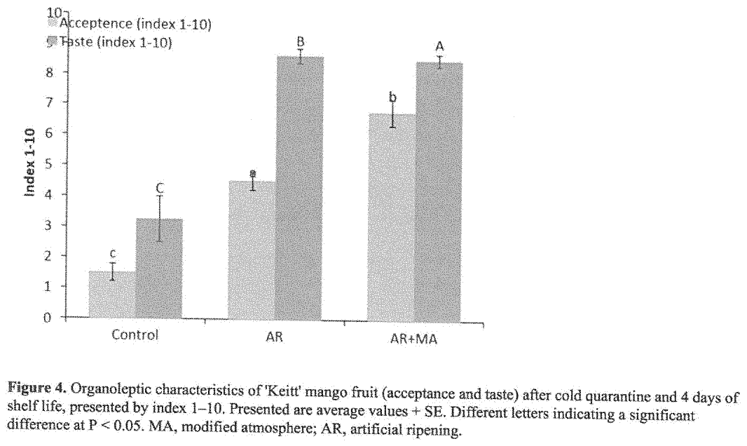

During fruit ripening, acids are degraded and sugars increase, leading to a higher sugar-to-acid ratio-the key parameter determining acceptance and taste among consumers. As shown in FIG. 4, experimental groups had higher acceptance and taste index values after cold quarantine compared to controls. Experimental groups' fruits were characterized by low chilling injury vulnerability during cold quarantine, they had high quality including combination of good taste and aroma.

Chilling Injury in Mango fruit

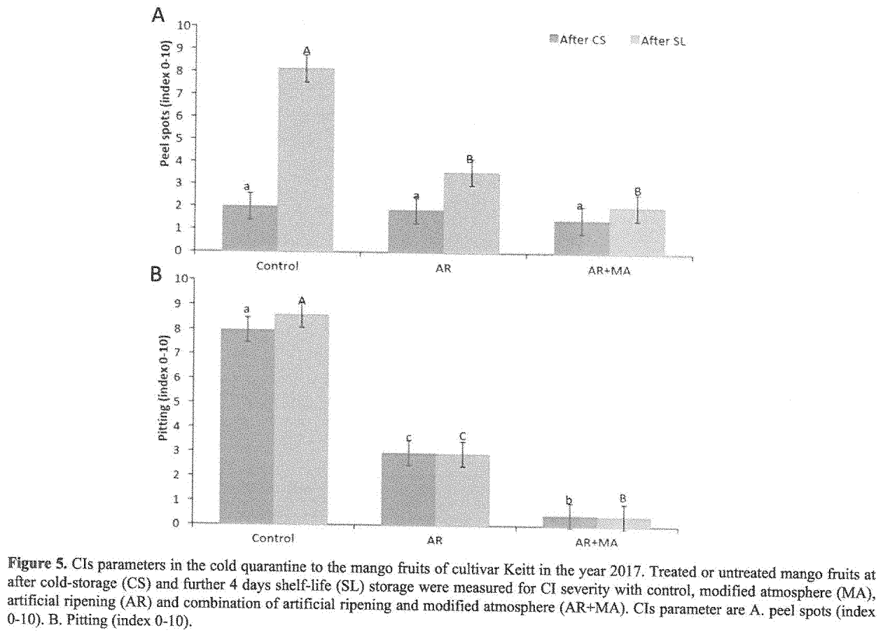

Quality level required for marketing was achieved with a combination of artificial ripening and modified atmosphere. Severity of chilling injury in terms of black peel spots and pitting were evaluated by a chilling (cooling) injury (CI) index on a scale of 0 through 10, with 0 being no chilling injury and 10 being severe chilling injury, as shown in the graphs appearing in FIG. 5, Parts A and B, respectively. Marketing quality is considered when the CI Index is less than 2, for black spots and less than I for pitting. Implementing a combination according to aspects of the invention including artificial ripening (AR), modified environment (MA), (and low temperature conditioning (LTC)), led to reduction in CI Index to a level that was acceptable to consumers (FIGS. 4 and 5, and Tables 1 and 2).

Cooling injury (CI) is known to be strongly correlated with elevated production of reactive oxygen species (Cao et al., “Melatonin increases chilling tolerance in post-harvest peach fruit by alleviating oxidative damage”, in Scientific Reports, 8, 806 (2018)), which lead to lipid peroxidation and degradation. The detection of fruit luminescence by in-vivo imaging systems can non-destructively pinpoint early lipid peroxidation (Sivankalyani, et al., “Transcriptome dynamics in mango fruit peel reveals mechanisms of chilling stress”, in Frontiers in Plant Science, 7 (2016), https://doi.org/10.3389/Fpls.2016.01579). In these Examples, the integrated treatments of artificial ripening plus modified atmosphere had lower luminance, indicating reduced lipid peroxidation (FIG. 2, Part B) and chilling injury. This lower lipid peroxidation was also expressed in reduced degradation of linolenic acid and reduced oxylipin C6 and C9 volatiles such as hexanal and nonanol (FIG. 2, Part A), which are associated with lipid peroxidation and chilling stress in mango fruit (Sivankalyani, et al., “Chilling Stress Upregulates a-Linolenic Acid-Oxidation Pathway and Induces Volatiles of C6 and C9 Aldehydes in Mango Fruit”, in Journal of Agricultural and Food Chemistry, 65, 632-638 (2017)) (hereinafter referred to as “Sivankalyani, et al. (2017)”).

Analysis of Mango Aroma Volatiles and Consumer Acceptance

Gas chromatography-mass spectrometry analysis of mango aroma volatiles a-Terpinen, 1R-α-Pinene, β-Pinene, Terpinolen, and 3-Carene after cold storage (CS) of artificially ripened treated fruit showed their increase (FIG. 3). Additionally, cold storage of artificially ripened treated fruit showed reduced cooling injury (CI), and good taste leading to high levels of consumer acceptance. The results presented here show that after cold storage, the fruit was ready to eat. The ready-to-eat fruit could be held at 20° C. for up to 4 days with the maintenance of relatively good quality and low decay.

Materials and Methods

Fruit Materials—Mid-season mature, full-size and unripe mango fruit (Mangifera indica L.) were harvested in August of 2015 and August 2017 (Keitt) and August 2016 (Shelly), and transported (1 hour) (in ambient environment) from the Mor storage facility to the Agricultural Research Organization, Volcani Center, Israel. Export-class “Keitt” and “Shelly” fruit (mangos) weighed between 390 grams (g) and 450 g, with nine “Keitt” fruit, and ten “Shelly” fruit per cardboard box in the cold quarantine experiment. The fruit was stored at 2° C. for 19 days, with or without the post-harvest treatments detailed below.

Post-Harvest and Cold Quarantining Treatments

Artificial Ripening (AR)—Harvested fruit was artificially ripened with 150 ppm ethylene followed by 2 days of storage at 18° C.

Modified Atmosphere (MA)—Fruit was enclosed in low-density-perforated (30 holes of 0.5 mm) polyethylene bags (StePac, Israel), removed from the bag after 1 day to avoid condensation (97-98% relative humidity, 4-7% CO₂). The controls were not subjected to a modified atmosphere.

Low Temperature Conditioning (LTC)—Temperature was gradually reduced over 3 days: day 1 temperature was 12° C. (relative humidity was 74.80%), day 2 temperature was 5° C. (relative humidity was 86.90%), and day 3 temperature was 2° C. (relative humidity was 91.80%). Untreated fruits were stored at a 2° C. for 19 days (fruit core temperature of 2 ±0.25° C.). Cold quarantine was followed by 4 days of shelf-life at 20° C. (relative humidity was 63.3%). Five cardboard boxes, containing 9 fruits (Keitt) or 10 fruits (Shelly), were used for each treatment replication. The room temperature was monitored by a DAQ tool—double strand wire logger/data acquisition control system (T.M.I. Barak Ltd., Israel). Fruit core temperatures were monitored using a MicroLite data Logger LITE5032P-EXT-A (Fourier Technologies, Israel) by inserting its probe 3 cm deep into the mango, near to the mango stone.

Physiological Measurements

Chilling injury symptoms of mango fruits were examined after cold storage (2° C. for 19 days) and shelf life (20° C.) storage. Chilling injury severity in terms of black peel spots and pitting were evaluated by CI index (on a scale of 0-10, with 0 being no chilling injury and 10 being severe chilling injury). Other physiological parameters were rated on relative scales: color (scale of 1-10; 1=green, 10=orange); fruit firmness (scale of 1-10; 1=soft, 10=firm); decay severity (scale of 0-10; 0=no decay, 10=severe decay), and decay incidence presented as percentage of decayed fruit in a box.

Other post-harvest parameters were measured using instruments. Firmness was tested via the peel using an 11-mm probe penetrometer (LT-Lutron FG-20 kg, Indonesia) at two points on each fruit (10 fruit per treatment). Fruit color (hue) was measured by chromometer (Minolta LR-400/410) at two points on each fruit (10 fruit per treatment). Fruit total soluble solids (TSS) were measured by a digital refractometer (ATAGO PR-1, Japan) and presented in percent Brix (% TSS). Acidity concentration was measured by an automatic titrator (Metrohm, 719S Titrino, Switzerland) and calculated based on percent citric acid.

Identification and Quantification of Volatiles

Aroma and lipid-peroxidation volatiles were identified and quantified by gas chromatograph 7890A and mass chromatograph 5975C (Agilent Technologies Inc., USA). After cold-quarantine treatment, mango peel samples (1 g) were collected randomly from five fruit of each replicate in three biological repeats for cultivar (cv.) Keitt in 2017. Samples were immediately stored with 2 mL NaCl (20% w/v) to stop further enzymatic activity in 20-mL dark-colored glass bottles (LaPhaPack, Germany) with a tight seal. S-2-octanol (Sigma-Aldrich) was used as the internal standard. In each run, NaCl without sample was used as a control. Analytical conditions for the GC-MS run were adjusted as described by Sivankalyani, et al. (2017). Volatile identification was based on NIST mass spectral database version 5. Identified volatiles were quantified based on internal standard linear retention indices and expressed as μg/kg fresh weight (FW).

Fruit Organoleptic Characterization

To determine the sensory attributes of “Keitt” mango fruit after cold quarantine, acceptance and taste were evaluated by a tasting panel using an index of 1-10. These sensory attributes were judged for control, modified atmosphere (MA), artificial ripening (AR), and, AR plus MA, the fruit based on ranked general remarks on impression, sweetness, sourness and off-flavors.

Lipid Peroxidation and Luminescence

A pre-clinical in-vivo imaging system (Perkin Elmer, USA) and a highly sensitive charge-coupled camera (CCD) were used to detect alterations in the cellular membrane, caused by lipid peroxidation. Fruits of cv. Keitt after cold storage were re-acclimatized for 2 hours in the dark prior to in-vivo imaging system evaluation. Oxidative degradation of lipids was recorded at 640-770 nm wavelengths emitted for 20 min as proposed by Britic, et al., “Using spontaneous photon emission to image lipid oxidation patterns in plant tissues”, in The Plant Journal, 67, 1103-1105 (2011) and Sivankalyani, et al. (2017). Data was recorded for three biological replications, and one representative picture is presented, as shown in FIG. 2.

Statistical Analysis

Data from three different experiments are presented as average±standard error (SE). One-way Analysis of variance (ANOVA) was used to compare means of treatments to controls with JMP Pro 13.0 statistics software and data were subjected to Duncan's multiple-range tests. Differences at P<0.05 were considered significant. Indices for black spots (scale 0-10), pitting (scale 0-10), acceptance (scale 1-10), taste (scale 1-10), firmness (scale 1-10), yellowing (scale 1-10) and side-decay severity (scale 0-10) (the scales described above) were calculated with the formula:

$$Index = \sum \frac{Respective scale \times Number of fruit present at that level}{Total number of fruit in the treatment}$$

The present invention is suitable for almost all fruits, for example, citrus fruits, bell pepper, pomegranate, peaches, plums, nectarines, and avocado.

All publications, patent applications, and other references mentioned herein are incorporated by reference in their entirety.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A method for treating fruit comprising:
ripening the fruit;
subjecting the fruit to a modified atmosphere to slow the metabolism of the fruit; and,
conditioning the fruit for treatment by cooling processes, by gradually lowering the core temperature of the fruit by predetermined temperature amounts for predetermined time periods for a predetermined amount of time, to avoid cold shock in the fruit.

2. The method of claim 1, wherein the ripening includes artificial ripening.

3. The method of claim 2, wherein the artificial ripening includes subjecting the fruit to approximately 150 ppm ethylene in a ripening chamber.

4. The method of claim 1, wherein the modified atmosphere includes a CO₂ at a concentration of approximately 4-7 percent, and to O₂ at a concentration of approximately 16%.

5. The method of claim 1, wherein the conditioning includes cooling the fruit from core temperatures of approximately 12° C. to approximately 2° C., over a time period of at least three days, with each time interval being a day and the temperature difference between the time intervals no more than 7° C.

6. The method of claim 1, wherein the subjecting the fruit to the modified atmosphere includes covering the fruit within a porous polymeric bag.

7. (canceled)

8. (canceled)

9. (canceled)

10. (canceled)

11. (canceled)

12. The method of claim 1, wherein the subjecting the fruit to a modified atmosphere and conditioning the fruit are performed simultaneously.

13. The method of claim 1, wherein the fruit includes mango.

14. A method for treating fruit comprising:
artificially ripening the fruit; and,
conditioning the fruit for treatment by cooling processes, by gradually lowering the core temperature of the fruit by predetermined temperature amounts for predetermined time periods for a predetermined amount of time, to avoid cold shock in the fruit.

15. The method of claim 14, additionally comprising: subjecting the fruit to a modified atmosphere to slow the metabolism of the fruit.

16. The method of claim 14, wherein the artificial ripening includes subjecting the fruit to approximately 150 ppm ethylene in a ripening chamber.

17. The method of claim 14, wherein the modified atmosphere includes a CO₂ at a concentration of approximately 4-7 percent, and to O₂ at a concentration of approximately 8-16%.

18. The method of claim 14, wherein the conditioning includes cooling the fruit from core temperatures of approximately 12° C. to approximately 2° C., over a time period of at least three days, with each time interval being a day and the temperature difference between the time intervals no more than 7° C.

19. The method of claim 15, wherein the subjecting the fruit to the modified atmosphere includes covering the fruit within a porous polymeric bag, wherein the porous polymeric bag includes a porous polyethylene bag.

20. (canceled)

21. (canceled)

22. (canceled)

23. (canceled)

24. (canceled)

25. (canceled)

26. (canceled)

27. A method for treating fruit comprising:
subjecting the fruit to a modified atmosphere to slow the metabolism of the fruit; and,
conditioning the fruit for treatment by cooling processes, by gradually lowering the core temperature of the fruit by predetermined temperature amounts for predetermined time periods for a predetermined amount of time, to avoid cold shock in the fruit.

28. The method of claim 27, additionally comprising: artificially ripening the fruit.

29. The method of claim 28, wherein the artificially ripening the fruit includes subjecting the fruit to approximately 150 ppm ethylene in the ripening chamber.

30. (canceled)

31. The method of claim 27, wherein the conditioning includes cooling the fruit from core temperatures of approximately 12° C. to approximately 2° C., over a time period of at least three days, with each time interval being a day and the temperature difference between the time intervals no more than 7° C.

32. The method of claim 27, wherein the subjecting the fruit to the modified atmosphere includes covering the fruit within a porous polymeric bag wherein the porous polymeric bag includes a porous polyethylene bag and wherein the polyethylene is low density polyethylene (LDPE) and wherein the porous polyethylene bag includes pores of approximately 0.5 mm diameter.

33. (canceled)

34. (canceled)

35. (canceled)

36. The method of claim 32, wherein the covering the fruit within the porous polymeric bag includes one of: the bag being closed and the bag being open.

37. (canceled)

38. (canceled)

39. (canceled)
